(19) United States
(12) Patent Application Publication
(10) Pub. No.: US 2010/0173117 A1
(43) Pub. Date: Jul. 8, 2010

(54) POLYMERIC COMPOSITIONS FOR USE IN PREPARING A BALLISTIC MATERIAL

(76) Inventors: Leslie P. Duke, Silver Creek, GA (US); Wayne Barrett, Dahlonega, GA (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/522,507

(22) PCT Filed: Jan. 8, 2008
(86) PCT No.: PCT/US08/00243

§ 371 Date: Mar. 24, 2010

Related U.S. Application Data
(60) Provisional application No. 60/883,915, filed on Jan. 8, 2007.

(51) Int. Cl. B32B 27/32; C08L 23/06; B32B 3/02

(52) U.S. Cl. 428/80; 524/585; 428/220

(57) ABSTRACT

Polymeric compositions for use in preparing a ballistic material and ballistic materials capable of absorbing incoming projectiles prepared from the polymeric material are disclosed The resulting ballistic materials are also disclosed The materials have sufficient elasticity so that the polymer or polymer blend does not shatter when stuck with a high-velocity projectile The polymer blends ideally have one or more of the following physical properties—a) a modulus of elasticity in the range of around 12,500 psi and around 19,000-psi, b) a max stress psi in the range of around 545 and around 985, and c) a tensile strength in the range of around 3 50 ft-lbflιn and around 11 OO ft-lbf/ιn The thickness of the ballistic material is at least around 3 inches, with a size of around 4-5 inches square or diameter

### FIELD OF THE INVENTION

The invention is generally in the area of polymeric compositions for use in preparing a ballistic material, and in ballistic materials capable of absorbing incoming projectiles prepared from the polymeric material.

### BACKGROUND OF THE INVENTION

There is often a need to absorb incoming high velocity projectiles, such as bullets and the like. For example, armored vehicles and shooting ranges need to stop such high-velocity projectiles.

Although there are several types of armor known for stopping these projectiles, there are often limitations associated with these materials. For example, ceramic body armor tends to crack after being struck with a high-velocity projectile. It would therefore be advantageous to provide additional materials for stopping these projectiles. The present invention provides such materials, and articles of manufacture including these materials.

### SUMMARY OF THE INVENTION

The present invention generally relates to polymeric materials, which can be thermoset or thermoplastic elastomeric materials, capable of stopping one or more high speed projectiles, and articles of manufacture which include these polymeric materials.

In a first embodiment, the materials are intended for use in stopping pistol rounds and rim-fire rounds, such as 17 and 22 caliber rounds. In a second embodiment, the materials are intended for use in stopping these projectiles as well as higher velocity rounds, such as rifle rounds, up to and including 50 cal. BMG rounds, as well as other relatively high velocity projectiles.

In both embodiments, the materials can include a thermoplastic polymer, such as a polyolefin, and enough of an elastomer to allow the material to “re-heal” around a bullet, an elastomeric thermoset polymer, which re-closes over the hole created by a bullet due to the elastomeric properties, or blends thereof.

When the material is intended to stop pistol rounds and rim-fire rounds, such as 17 and 22 caliber rounds, the polymers, or blends thereof, have a density or a blended density of between about 0.795 and about 0.995 grams/cm³. When the material is intended to stop high velocity projectiles, such as rifle rounds, the density is between about 0.795 and about 1.25 grams/cm³. The desired density ranges can be achieved using polymer foams and/or by adding suitable filler materials.

The materials have sufficient elasticity so that the polymer or polymer blend does not shatter when stuck with a high-velocity projectile. Ideally, the polymer(s) will “re-heal,” or fuse back into a solid form without cracking, after being penetrated by a first projectile. The polymer blends ideally have one or more of the following physical properties:

a) a modulus of elasticity in the range of around 12,500 psi and around 19,000 psi,

b) a max stress psi in the range of around 545 and around 985, and

c) a tensile strength in the range of around 3.50 ft-lbf/in and around 11.00 ft-lbf/in.

It is generally been observed that when the material is intended to be subjected to relatively higher velocity projectiles, it is desirable to include a slightly higher amount of elastomeric polymer in the material.

Ballistic apparatus made with the thermoplastic and/or thermoset elastomeric polymeric materials were observed to prevent projectiles from penetrating more than about four or five inches or so. When projectiles penetrated further, the initial hole of entry closed very rapidly, trapping the bullet in the apparatus.

Any low-density thermoplastic polymers, thermoset elastomers, or blends thereof, which have the desired density and elasticity, or which can be blended with a sufficient amount of elastomers to provide the desired density and elasticity, to survive at least one or more impacts with high-velocity projectiles, can be used.

Those of skill in the art can readily evaluate polymers and polymer blends for their ability to stop incoming projectiles by preparing the material and subjecting it to impact with the projectiles. As can be appreciated, the thickness, length, and width will vary depending on a number of factors, including the intended application (i.e., practice targets or armor applications), and the selection of polymers.

The physical properties of polymers suitable for use in the present invention, such as LLDPE, include a density of 0.92 g/cm³, ±15%, a surface hardness of SD48, ±15%, a tensile strength of 20 MPa, ±15%, a flexural modulus of 0.35 GPa, ±15%, a linear expansion of 20×10−5/° C., ±15%, elongation at break of 500%, ±15%, strain at yield of 20%, ±15%, and a melting temperature range of around 120 to around 160° C.

The thermoplastic materials can be formed, for example, by injection molding, and the thermoset materials can be formed, for example, by reaction injection molding (RIM). In one embodiment, the monomers used in the reaction injection molding process comprise Dow system spectrum RW 509 (Polyol)+Isonate MDI 5181.

In another embodiment, the polymers include between about 59% and about 90% linear low density polyethylene (“LLDPE”) by weight of the polymers, between about 5% and about 40% Hybar™ (5125) by weight of the polymers, and between about 0 and about 35%, preferably between about 5 and about 35% Engage (8100), by weight of the polymers.

The bullet block configuration, designed to stop rimfire and pistol rounds, is typically at least around 3 inches in thickness, and at least around 4-5 inches square, or in diameter, if round, and equivalent sizes if other shapes are employed. The maximum effective size is limited only by the available space.

When the material is intended to stop high velocity projectiles, such as rifle rounds, objects made of a hardened material, such as steel and the like, are interspersed throughout the interior volume of the material. The size of these objects ranges between about ¼ and ½ inch, and the objects can be positioned in any suitable pattern that provides an effective impediment to the path of the incoming projectile. Depending on the intended use, the patterns can be used to stop incoming fire from the front and/or back, the sides, and the top and/or bottom. The simplest way to ensure that there is an object in the path of a projectile is to place the objects in a plane throughout the material, in each direction in which a projectile can enter the material. The objects are positioned a certain depth within the material to enable the polymer to reduce the velocity of the projectile, and with a certain depth of the material behind the object to catch any fragments formed when the projectile strikes one or more objects.

A plurality of blocks can be connected to each other by providing the blocks with interlocking portions, such as male and female connectors and the like. Ideally, where there are seams that might permit entry of a high-velocity projectile, there is sufficient material from another block, or from another portion of the same block, to provide adequate protection. Structures comprising a plurality of these blocks, ideally interlocked via the connecting means described above, are also within the scope of the invention. Representative articles of manufacture include backstops for firing range and home use, armor for vehicles and aircraft, training targets, protection for temporary or mobile military and/or police installations, buildings, bunkers, pipelines and/or any “critical need” equipment which might require protection from ballistic impact, and the like. The materials can be used as or in firearm backstops, e.g., at a firing range or live-fire training facility, and as protective ballistic armor disposed adjacent to a structure to be protected, such as building structures, ground vehicles, aircraft, spacecraft, and ships.

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings can be expanded or reduced to more clearly illustrate the embodiments of the invention.

### BRIEF DESCRIPTION OF THE DRAWINGS

FIGS. 1-3 are schematic illustrations of various interlocking blocks made from materials described.

### DETAILED DESCRIPTION

The present invention will be better understood with reference to the following detailed description. Those skilled in the art will appreciate the above stated advantages and other advantages and benefits of various additional embodiments by reading the following detailed description, particularly with reference to the above-referenced figures.

According to common practice, the various features of the drawings discussed below are not necessarily drawn to scale. Dimensions of various features and elements in the drawings can be expanded or reduced to more clearly illustrate the embodiments of the invention.

### I. Materials Intended for Stopping Pistol and Rim Fire Rounds

In one embodiment, the materials are intended for use in stopping pistol rounds and rim-fire rounds, such as 17 and 22 caliber rounds.

### II. Materials Intended for Stopping High Velocity Projectiles

In another second embodiment, the materials are intended for use in stopping high velocity projectiles, such as rifle rounds, up to and including 50 cal. BMG rounds, as well as other relatively high velocity projectiles, in addition to the lower velocity pistol and rim-fire rounds.

### III. Polymeric Materials Useful for Preparing the Materials

In one aspect of both embodiments, the materials include a thermoplastic polymer, such as a polyolefin, and enough of an elastomer to allow the material to “re-heal” around a bullet. The blends of thermoplastic polymers with elastomers are selected to provide advantageous projectile-stopping properties.

In another aspect of both embodiments, the materials include an elastomeric thermoset polymer, which re-closes over the hole created by a bullet due to the elastomeric properties, even though it does not melt and “re-heal” like the thermoplastic polymers. In a third aspect, the materials include both a thermoplastic polymer and an elastomeric thermoset polymer.

In the first embodiment, when the material is intended to stop pistol rounds and rim-fire rounds, such as 17 and 22 caliber rounds, the blends of the thermoplastic polymer and the elastomer have a blended density of between about 0.795 and about 0.995 grams/cm³. In the second embodiment, the blends of the thermoplastic polymer and the elastomer have a blended density of between about 0.795 and about 1.25 grams/cm³. The desired density ranges can be achieved using polymer foams, for example, by incorporating blowing agents into the polymeric material as it is extruded to form articles of manufacture. Density can also be controlled by adding suitable filler materials.

The blends of thermoplastic and elastomeric polymers, and/or the elastomeric thermoset polymers, have sufficient elasticity so that the polymer or polymer blend does not shatter when stuck with a high-velocity projectile. Ideally, the polymer(s) will “re-heal,” or fuse back into a solid form without cracking, after being penetrated by a first projectile.

The polymer blends ideally have one or more of the following physical properties:

a) a modulus of elasticity in the range of around 12,500 psi and around 19,000 psi,

b) a max stress psi in the range of around 545 and around 985, and

c) a tensile strength in the range of around 3.50 ft-lbf/in and around 11.00 ft-lbf/in.

It is generally been observed that when the material is intended to be subjected to relatively higher velocity projectiles, it is desirable to include a slightly higher amount of elastomeric polymer in the material.

Examples of suitable thermoplastic and thermoset materials are described in more detail below.

A. Thermoplastic Materials

There are a number of suitable low-density thermoplastic polymers that have the desired density and elasticity, or which can be blended with a sufficient amount of elastomers to provide the desired density and elasticity, to survive at least one or more impacts with high-velocity projectiles. There are likewise a number of suitable thermoset elastomeric polymers that have the desired density and elasticity, or which can be blended with a sufficient amount of elastomers to provide the desired density and elasticity, to survive at least one or more impacts with high-velocity projectiles.

Representative thermoplastic polymers include linear low density polyethylene (LLDPE). Representative thermoplastic polymers include, but are not limited to, LL 6100 and LL 6200 (Exxon Mobil), Dowlex® LLDPE 1002.09 and 1002.28, Montell® 16502F3 Butene LLDPE, Novacor® PI 2024a, 2035, 2037, and 2045A LLDPE, elastomers such as Dow NG3310 (a linear low density polyethylene copolymer containing 93% by weight ethylene and 7% by weight octene), 1300, 8250, 1280, Dow Affinity™ EG8150G and EG8200 polyolefin plastomers, 58200.03 and other polyethylenes disclosed in U.S. Pat. No. 6,270,891, the contents of which are hereby incorporated by reference, damping agents such as Hybrar® elastomers such as Hybrar® 4033, 4055, 5125, 8004, 2004, 8007, 7125, and 8006, and Engage™ 8100 or Engage™ 8200. Hybrar™ are a series of high performance thermoplastic rubbers developed by Kuraray Co., LTD. These thermoplastic rubbers have high vibration damping properties at room temperature, and are commercially available in both hydrogenated and non-hydrogenated grades. In addition to superior vibration damping properties, the hydrogenated grades also exhibit excellent miscibility with polypropylene, and may be used to produce blends with excellent flexibility and mechanical properties. Hybrar™ is available in a triblock type having polystyrene blocks and a vinyl bonded rich polyisoprene block. Engage is a polyolefin plastomer, comprising a co-polymer of ethylene and octane. Engage 8100 (also known as EG8100G) has a specific gravity of between 0.85 and 0.91.

The physical properties of LLDPE include a density of 0.92 g/cm³, a surface hardness of SD48, a tensile strength of 20 MPa, a flexural modulus of 0.35 GPa, linear expansion of 20×10−5/° C., elongation at break of 500%, strain at yield of 20%, and a melting temperature range of 120 to 160° C. Polymers which have properties within about 15% of these ranges, in either direction, are suitable for use in the materials described herein.

When the materials, and articles that include the materials, are intended to stop pistol rounds or rimfire rifle rounds, such as 17 caliber or 22 caliber rifle rounds, the following has been observed. A material prepared from 100% LLDPE will stop a few bullets, from 38 special to 9 mm, but will not re-heal, and tends to crack upon impact. However, by incorporating about 20% by weight of a damping agent and about 10% by weight of an elastomer, the material is capable of stopping and containing a relatively high number of rounds such as 38 special, 22 long rifle, 22 short rifle, 40 cal., 45 cal., 9 mm, 357 magnum, and 22 magnum rifle rounds. In one embodiment, a “bullet block” prepared from the material stopped a minimum of 5,000 rounds.

Accordingly, in one embodiment, the polymers include between about 59% and about 90% linear low density polyethylene (“LLDPE”) by weight of the polymers, between about 5% and about 40% of a damping agent/elastomer, by weight of the polymers. Within this embodiment, the following compositions have been successfully evaluated: a) 59% by weight of LLDPE and 40% by weight damping agent; b) 59% by weight of LLDPE, 5% by weight of damping agent, and 35% by weight elastomer; c) 94% by weight of LLDPE and 5% by weight damping agent; d) 94% by weight LLDPE and 5% elastomer; 69% by weight of LLDPE, 20% damping agent, and 10% by weight elastomer.

When the materials, and articles that include the materials, are intended to stop higher velocity projectiles, such as rifle rounds, the following has been observed. As with the first embodiment, material prepared from 100% LLDPE will stop a few bullets, but will not re-heal, and cracks upon impact. However, incorporation of at least about 20% by weight of a damping agent or an elastomer will enable the material to stop and contain a relatively high number of rounds such as 38 special, 22 long rifle, 22 short rifle, 40 cal., 45 cal., 9 mm, 357 magnum, and 22 magnum rifle rounds.

In one embodiment of the material used to stop high velocity projectiles, the polymers include between about 59% and about 90% linear low density polyethylene (“LLDPE”) by weight of the polymers, between about 5% and about 40% preferably between about 5 and about 35%, of an elastomer/damping agent, by weight of the polymers. In another embodiment, the materials include about 79% LLDPE by weight of the polymers, and about damping agent by weight of the polymers.

The materials can typically be formed by injection molding, which typically involves obtaining solid particles (such as chips) of the thermoplastic polymer(s), melting them, and placing the molten thermoplastic materials in a suitable mold. After cooling, the resulting material is removed from the mold.

The manner in which the thermoplastic material inhibits penetration of high-velocity projectiles can be described generally as follows. As a high-velocity projectile enters the material, its kinetic energy is converted into heat; and the thermoplastic polymers in the region in front of the projectile are compressed and melted. The molten polymer then flows past the projectile into the region behind the projectile, where it cools and hardens. The result is that the track of the projectile is of smaller diameter than the projectile itself. Further, because the molten region ahead of the projectile generally extends beyond the diameter of the projectile itself, the shear stress imposed by the surface of this molten polymer volume moving through the solid provides an additional sink for the kinetic energy of the projectile.

Also, when the polymer is pulled or stretched in this super heated state, it cools quickly, and reverts to its congealed state. As it cools, the thermoplastic polymeric material attempts to return to its original position. As a result, the cooling polymer acts like an extremely aggressive adhesive with respect to anything it contacts, such as a spinning projectile. This adhesion can be promoted by using a compatible adhesion promoting agent, such as polyethylene acrylic acid.

Ballistic apparatus made with the thermoplastic polymeric material were observed to prevent projectiles from penetrating more than about four or five inches. When projectiles penetrated further, the initial hole of entry closed very rapidly, trapping the bullet in the apparatus. Because of the energy absorbing properties of the thermoplastic polymeric material, and the expansion of the polymeric material as it cools, the projectile is truly captured by the apparatus with no chance of escape, and stops within a short distance.

For projectiles that are spinning (e.g., projectiles fired from a rifled barrel or rifled slugs fired from a smooth bore barrel, such as a shotgun), it is believed that the energy resulting in the rotational motion of the projectile is at least partially dissipated by the shear between any projectile surface in contact with polymer, and by the pumping action that the projectile rotation exerts on the molten polymer. Rotation of the projectile effectively pumps molten polymer to the rear of the projectile, dissipating the projectile energy, and helping to slow its forward motion (in much the same way that a twist drill ceases to penetrate a wood block when it stops rotating).

Those of skill in the art can readily evaluate polymers and polymer blends for their ability to stop high-velocity projectiles, for example, by preparing the material in a form that has a desired thickness, length, and width for the intended application, and subjecting it to impact with high-velocity projectiles. As can be appreciated, the thickness, length, and width will vary depending on a number of factors, including the intended application (i.e., practice targets or armor applications), and the selection of polymers.

B. Thermoset Materials

Any thermoset polymer(s) can be used that provides adequate elasticity such that the material can stop incoming projectiles. Representative thermoset elastomeric polymers include elastomeric polyurethanes, such as those described, for example, in U.S. Pat. No. 6,271,305 to Rajalingam et al., EPDM (an elastomeric compound that is manufactured from ethylene, propylene, and a small amount of diene monomer), and the thermoset elastomeric materials described in U.S. Pat. No. 5,869,591, the contents of which are hereby incorporated by reference. Also suitable are thermoset systems like Bayflex 110-50, 110-35, and 110-80, and MP10000 (Bayer Corporation). In one embodiment, the monomers used in the reaction injection molding process comprise Dow system spectrum RW 509 (Polyol)+Isonate MDI 5181.

The thermoset materials are typically prepared by reaction injection molding (RIM). For example, polyurethane reaction injection molding (RIM) can be used to prepare thermoset polyurethane RIM elastomeric parts, which tend to have relatively high strength and relatively low weight. Like thermoplastic injection molding, RIM uses molds to form parts.

RIM is capable of providing thermoset resins with a broad range of properties. The reaction involves the reaction of two liquid components, unlike the conventional pellet form of most thermoplastics used in injection molding. These liquid components—an isocyanate and a polyol—are often referred to as polyurethane RIM systems.

Depending on how the polyurethane RIM system is formulated, the resulting molded parts can be a foam or a solid, and can be made relatively flexible (i.e., elastomeric).

In RIM processing, the two liquid components are held in separate, temperature-controlled feed tanks equipped with agitators, and then fed through supply lines to metering units which meter both components, at high pressure, to a mixhead device. The components are then subjected to high velocity impingement in a mix chamber, and the mixed liquids then flow into the mold at approximately atmospheric pressure. Inside the mold, the liquid undergoes an exothermic chemical reaction, which forms the polyurethane polymer.

The manner in which the thermoset elastomeric material inhibits penetration of high-velocity projectiles can be described generally as follows. As a high-velocity projectile enters the material, it punches a hole in the thermoset elastomeric material. Unlike the thermoplastic material, which melts and then flows around the projectile, the thermoset elastomeric material does not crack, but rather, spreads open to form a hole into which the projectile enters. Due to the thermoplastic nature of the thermoset polymer, after the bullet passes through the hole, the elastomeric nature of the material allows it to re-close the hole around the space created by the projectile. Thus, unlike the thermoplastic material, which re-forms around the projectile, the thermoplastic material re-closes around the projectile, leaving behind a seam where the projectile originally entered the material.

Ballistic apparatus made with the thermoset polymeric material were also observed to prevent projectiles from penetrating more than about four or five inches or so. When projectiles penetrated further, the initial hole of entry re-closed very rapidly, trapping the bullet in the apparatus. The energy absorbing properties of the thermoplastic polymeric material capture the projectile, with no chance of escape, within a relatively short distance.

For projectiles that are spinning (e.g., projectiles fired from a rifled barrel or rifled slugs fired from a smooth bore barrel, such as a shotgun), as with the thermoplastic material, it is believed that the energy resulting in the rotational motion of the projectile is at least partially dissipated by the shear between any projectile surface in contact with the thermoset polymer.

C. Optional Additional Components

Rubbers (such as Vistalon®, natural rubber, CPE (chlorinated polyethylene), TPO (thermoplastic polyolefins), TPV (thermoplastic polyolefin vulcanite), or EPDM rubbers) can optionally be added to provide desirable energy absorption properties at low temperature uses (e.g., in arctic or Antarctic environments). Fibers and ceramic fillers can optionally be added to help provide density changes and initiate tumbling in high temperature uses (e.g., in desert or tropical environments). Inclusion of both types of additives can provide a material suitable for use in a wide range of environments.

The polymeric material can contain a number of other components to provide desirable properties, including orienting the polymer chains during extrusion, entangling the polymer chains, and providing density gradients within the polymeric material to induce early tumbling or aspect ratio change. Typical compositions include (percentages are by weight based on the total weight of polymeric material):

Acrylic acid (for adhesion control, in amounts ranging from about 0.25 to about 10%;

Macro and micro fibers, such as silica, alumina, or organic fibers, in amounts ranging from 0 to about 50%, more particularly from about 5 to about 10%;

Peroxide-containing or silane-containing curing agents, in amounts ranging from 0 to about 4%; the material can contain at least two different types of silanes simultaneously, which may each perform independent functions: (1) a curing silane, typically a vinyl silane used with peroxide and catalyst; and (2) a treatment silane, typically of the amino or epoxy types for pigment treatment, to control coupling and melt rheology.

Colorants, in amounts ranging from 0 to about 12%; Plastomer (for control of crystallinity and curing) in amounts ranging from 0 to about 20% (e.g., ENGAGE® 8540 (Dupont Dow); EXXACT® 2030 (Exxon), etc.);

Vistalon rubber (for control of crystallinity and to provide entanglement at low temperatures) in amounts ranging from 0 to about 30%;

Natural rubber (desirably in crumb form, to provide elasticity and as a filler) in amounts ranging from 0 to about 25%;

EPDM rubber (desirably in crumb form, to provide low temperature entanglement) in amounts ranging from 0 to about 50%;

Grafting/crosslinking catalyst(s) (such as catalyst T-12, Air Products, Inc.) in amounts ranging from 0 to about 0.5%;

Lubricants (such as a wax or metal stearate, such as zinc stearate) in amounts ranging from 0 to about 12%;

Wetting agents (such as stearic acid) in amounts ranging from 0 to about 4%;

Fillers (such as ceramic (e.g., silica, alumina, and/or zirconia) plates, powders (particularly those having high aspect ratios), and/or spheres) in amounts ranging from 0 to about 30%;

Vulcanizing agents (such as sulfur-containing crosslinking compounds) in amounts ranging from 0 to about 8%. It is understood that, when vulcanizing agents are used, zinc oxide and zinc containing derivatives can be included to accelerate the reaction, and magnesium oxide (such as Mag-lite “D” from Merck) can be used to modify and stabilize the vulcanization mechanisms. Additional components can include fire retardants, such as magnesium hydroxide, boric acid, zinc borate, aluminum trihydrate, and various clays including but not limited to montmorillonite, talc, bentonite, and kaolin (nano-clays).

### IV. Incorporation of Objects Into the Materials

In one aspect of this embodiment, objects made of a hardened material, such as steel and the like, are interspersed throughout the interior volume of the material. The size of these objects ranges between about ¼ and ½ inch. The objects can be placed in the material in various arrangements to retard the penetration of the projectiles through the material.

In one embodiment, the hardened objects comprise ceramic materials. As used herein, the term “ceramic” can include, but is not limited to, materials made from zirconia, alumina, borates, and/or silica. The ceramics may be sintered (e.g., fired in a kiln to develop their grain size) or unsintered. They may be shaped into desired forms, e.g., spheres, plates and/or very fine to coarse beads. Examples of silicas include glass, noveculite, quartz, sand, each having various particle sizes, and combinations of these. Ceramics made from cements of silica, Portland cement, alumina cements, magnesium oxide cements, phosphorate cements, and/or hydrocements are especially good and very economical. They have compression values of 15,000 to 60,000 psi without sintering in a kiln. These ceramic cements can combined with the polymeric material of the invention and can then be shaped from a liquid and poured into a void, which forms a mold for the apparatus of the invention. They may be pre-formed into plates, spheres or any other desired shape with the resulting material having the approximate hardness of sintered ceramic. Polymer ceramic cement versions used are so flexible they can stop projectiles without shattering completely.

It is believed that such hardened objects increase the ability of the armor assembled from the blocks to absorb incoming projectiles in at least two ways. First, the directional path of an incoming projectile that encounters one of the hardened objects is deflected in such a manner as to increase the rate at which the projectile decelerates as it penetrates into the armor. Second, incoming projectiles may become deformed, disintegrate, or shatter upon encountering one or more of the hardened objects and such deformation, disintegration, or shattering will also tend to impede penetration into the armor. When these objects are present in the material, and the material includes an appropriate blend of thermoplastic and elastomeric polymers, the material can even stop high velocity rounds such as 50 cal. BMG.

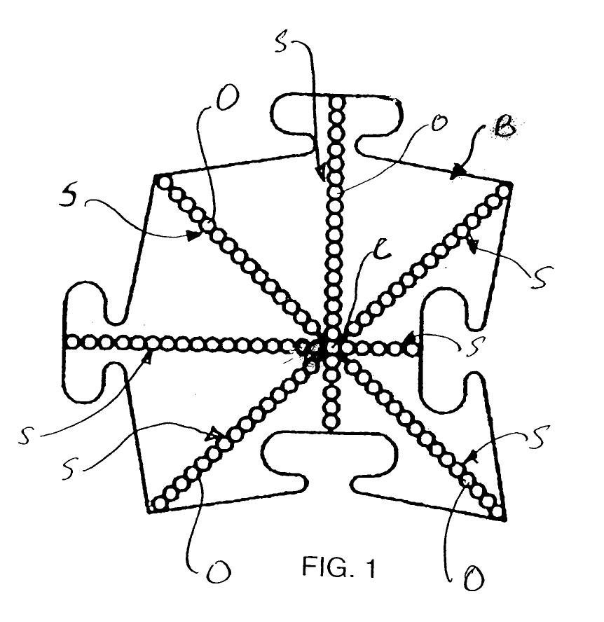

FIGS. 1-3 are schematic illustrations of exemplary patterns in which the objects are oriented in the materials to provide an impediment to the path of oncoming projectiles. Each of the Figures are a schematic representation of a horizontal cross-section of a block B made from material of the present invention and having the objects O interspersed within the interior of the block. In FIG. 1, the objects O are arranged as illustrated in U.S. patent application Ser. No. 11/180,843, which is incorporated by reference herein for all purposes. The objects O are arranged in a plurality of two-dimensional matrix structures S that extend radially outward from a central location C within the interior of the block B forming a “star” configuration similar to spokes of a wheel extending radially outward from the central location. Each matrix structure S includes a single, radial row of hardened objects O arranged in multiple vertical columns, each vertical column extending from a bottom surface of the block B to a top surface of the block.

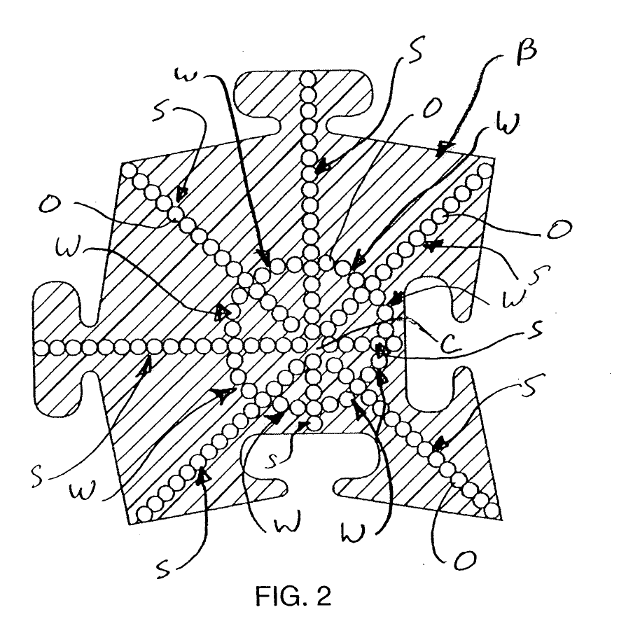

FIG. 2, illustrates an alternative arrangement of the objects O that includes the matrix structures or spokes S oriented in the “star” configuration. In FIG. 2, the block B includes arcuate walls W of hardened objects O between respective spokes S. Each arcuate wall W includes a plurality of vertical columns of hardened objects O so that the walls form a generally circular barrier surrounding the central location C extending the height of the block.

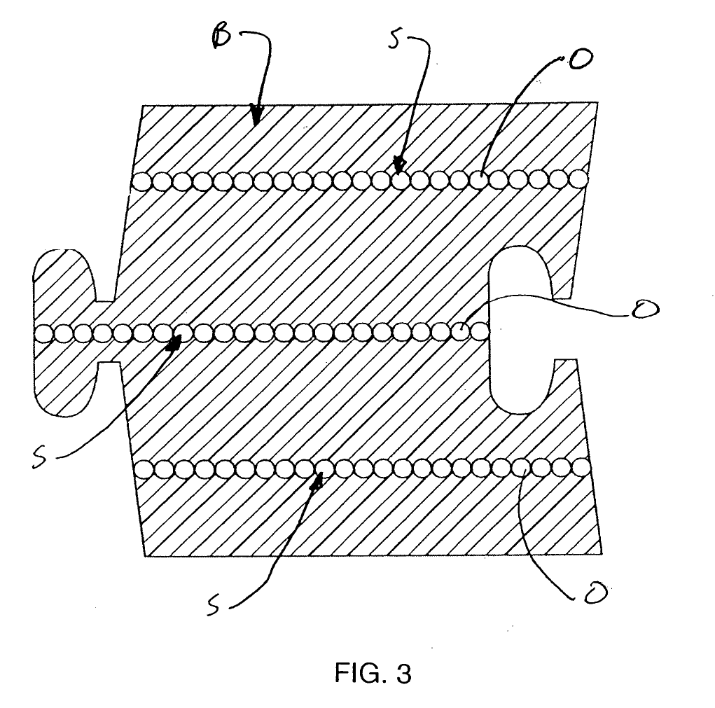

FIG. 3, illustrates an alternative arrangement of the objects O that includes three parallel two-dimensional matrix structures S of hardened objects O. In FIG. 3, one of the structures S passes through the middle of the block B, and the other two structures are spaced apart from and generally parallel to the middle structure. As with the previous embodiments, the matrix structures S of FIG. 3 include a plurality of vertical columns of objects O that extend from the bottom of the block to the top of the block to impede the penetration of a projective that enters at any vertical location or angle into the block.

Reference is made to the co-assigned U.S. patent application Ser. No. 11/620,180, filed Jan. 8, 2007 having attorney docket number B219 1021.1, which is incorporated by reference herein for all purposes, for additional information and orientations of the hardened objects O in the block B. Further, it is contemplated that the hardened objects could be otherwise, arranged or could be omitted from the material for impeding penetration of the projectile without departing from the invention. Other patterns can be used, but in any embodiment, the patterns ideally position a solid object in any possible path in which a high velocity projectile can enter the material. The objects in the patterns are ideally spaced at least about 1-3 inches, typically about 4-5 inches, inside the material, so that the incoming projectile has contact with at least some of the polymeric material before coming into contact with the object. Also, the objects are ideally spaced such that any fragments resulting from the projectile hitting the objects have sufficient polymeric material behind them to catch such fragments.

In the two dimensional and/or three dimensional blocks, the objects are present in a concentration of between about 2500 ball bearings in the star pattern, and between about 5 and about 40 percent of the total volume of the polymeric material, typically between about 8 and 20 percent of the volume. When used in patterns that only stop objects in one or two dimensions, the volume can be as low as 3 percent of the total volume of polymeric material, but are typically present in about 5 to about 10 percent of the total volume.

### V. Configuration of the Materials

The bullet block configuration, designed to stop rimfire and pistol rounds, is typically at least around 3 inches in thickness, and at least around 4-5 inches square, or in diameter, if round, and equivalent sizes if other shapes are employed. The maximum effective size is limited only by the available space.

When the material is intended to stop high velocity projectiles, the thickness of the material is at least around 4-5 inches, and the height and width are ideally at least about 8-9 inches, more typically at least around 12 inches, but the upper limit of the size is limited only by the available space. As discussed in more detail below, the material can be formed into interlocking shapes, and thus form a protective shield of virtually any size and shape.

The materials that optionally include the hardened materials can be formed into relatively lightweight polymeric blocks that are readily assembled into a projectile absorbing armor or into readily-assembled building block shapes. One embodiment of the block shapes is shown in FIG. 4, in which the blocks can interlock in three dimensions.

In one embodiment, the material is formed into “building blocks” so that one can construct a projectile absorbing armor that includes a plurality of the blocks. This can be accomplished using means known in the art.

One means for connecting a plurality of blocks is to provide the blocks with interlocking portions, such as male and female connectors. Male and female connectors allow the blocks to be connected in a horizontal fashion. As with conventional log home construction, the polymeric materials can include a projection on a top or bottom surface, and a recess on the bottom or top surface, respectively. The projection and recess enable the blocks to be stacked in a vertical fashion. However, other means of connecting a plurality of blocks can be envisioned, and any arrangement that allows the blocks to be assembled in a desired shape, to provide a desired level of protection, can be used. Ideally, where there are seams that might permit entry of a high-velocity projectile, there is sufficient material from another block, or from another portion of the same block, to provide adequate protection.

As the angle of incidence to the surface plane of the block increases, the ability of the polymeric material to capture and absorb projectiles varies in accordance with the velocity of the projectile and the density of the polymer. Relatively low velocity projectiles encountering the surface plane of the armor of the block at a relatively high level of incidence tend to bounce or ricochet off the material if the surface density is too high, for example, around 0.95 to 1.5 g/cc or higher. Thus, it is advantageous in some cases to fabricate the block in multiple layers with an outward facing layer of a relatively low density material, at the surface of the block, and a second, interior layer of a relatively higher density material below the first layer, with both density ranges within the ranges stated above. In one embodiment, the layers are formed from the same polymer(s), but the relatively lower density layer is more highly foamed. Alternatively, two different polymeric formations may be joined together, with a lower density polymer disposed toward the direction of incoming projectiles.

### VI. Three Dimensional Objects Prepared From the Materials

Structures comprising a plurality of these blocks, ideally interlocked via the connecting means described above, are also within the scope of the invention. In one embodiment, the structures comprise a body formed at least partially of a polymeric material described herein, ideally with a plurality of hardened objects are within the material. The plurality of hardened objects can be arranged into a predetermined matrix selected to ensure that a projectile moving through the body is likely to encounter at least one of the hardened objects.

Representative articles of manufacture include backstops for firing range and home use, armor for vehicles and aircraft, training targets, protection for temporary or mobile military and/or police installations, buildings, bunkers, pipelines and/or any “critical need” equipment which might require protection from ballistic impact, and the like. The materials can be used as or in firearm backstops, e.g., at a firing range or live-fire training facility, and as protective ballistic armor disposed adjacent to a structure to be protected, such as building structures, ground vehicles, aircraft, spacecraft, and ships.

The present invention will be better understood with reference to the following non-limiting example.

### Example 1

### Composition for Reaction Injection Molding of a Ballistic Material

The following composition was prepared for use in stopping hand gun and rifle rounds. The polymeric material is a polyurethane, and the material is formed by reaction injection molding.

The polyurethane is prepared from a polyol and a polyisocyanate. In this example, the polyol is Dow® system Spectrum RW 509 (Polyol) and Isonate™ 5181 methylene diphenyl isocyanate (MDI). The ratio of isocyanate to polyol was typically about 0.420/1.

The following procedure was used to mold blocks of the ballistic material.

A reaction injection molding process was used, with a mold temperature ranging from 140° F. on the core and 150° F. on the cavity. The degree of nucleation was typically between about 1.0 and about 0.90 degrees API when the ballistic material was designed to stop rifle bullets, and between about 0.75 and 0.85 degrees API when the ballistic material was designed to stop handgun bullets. The tank pressure was 60 psi when the material was designed to stop handgun bullets, and 0 psi when the material was designed to stop rifle bullets. The re-circulation pressure for all processes was set at 80 psi.

The shot size (or “batch size”) for the material designed to stop handgun bullets was between around 40 to 48 lb shot, and for the material designed to stop rifle bullets, the shot size was 49 to 55 lb. The specific gravity of the polyol (RW509 POLYOL) was around 1.02, and the specific gravity for the isocyanate (MDI 5181 ISO) was around 1.22. In some embodiments of the material intended for use in stopping rifle bullets, ball bearings were added at an amount of between about 10 to about 12 pounds of ball bearings to about 49 to about 55 pounds of polymer.

Temperatures of the isocyate were generally kept at between about 95° F. to about 105° F., and temperatures of the polyol were generally kept at between about 95° F. and about 105° F.

The parts were molded with a 4 minute cure time, and each part was weighed to verify its density.

After the first part was molded and inspected, a plaque (3.5″ by 5.5″ by ¼″) of the material was prepared, and taken to a laboratory for evaluation of the physical properties using an Instron. Three dies were used, and tear strength, flexural modulus, and elongation at break were measured.

For materials prepared using the above-described RIM process, the physical properties were typically as follows:

a) the specific gravity ranged from between about 0.93 to about 1.12;

b) the flexural modulus ranged from a minimum of 43,500 psi for materials intended for use in stopping handgun bullets, and a minimum of 65,250 psi for materials intended to stop rifle bullets;

c) the elongation at break for materials intended for use in stopping handgun bullets was a minimum of 75%, and for materials intended for use in stopping rifle bullets, the minimum was 50%;

d) the minimum tear strength for materials intended for use in stopping handgun bullets 364 psi, and the minimum tear strength for materials intended for use in stopping rifle bullets was 510 psi.

The material can be prepared in just about any color, including the natural color of the resulting polymer, though black and red pigments have been added.

The foregoing description illustrates and describes various embodiments of the present invention. As various changes could be made in the above construction without departing from the scope of the invention, it is intended that all matter contained in the above description or shown in the accompanying drawings shall be interpreted as illustrative and not in a limiting sense. Furthermore, the scope of the invention covers various modifications, combinations, additions, and alterations, etc., of the above-described embodiments that are within the scope of the claims. Additionally, the disclosure shows and describes only selected embodiments of the invention, but the invention is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the invention without departing from the scope of the invention.

What is claimed is:

1. A ballistic material comprising a polymer or polymer blend which does not shatter when stuck with a high-velocity projectile.

2. The ballistic material of claim 1, wherein the polymer or polymer blends have one or more of the following physical properties:
a) a modulus of elasticity in the range of around 12,500 psi and around 19,000 psi,
b) a max stress psi in the range of around 545 and around 985, and
c) a tensile strength in the range of around 3.50 ft-lbf/in and around 11.00 ft-lbf/in.

3. The ballistic material of claim 1, wherein the material includes an elastomeric polymer.

4. The ballistic material of claim 1, wherein the material is at least about three inches in thickness, with a length and width, if square or rectangular, a diameter, if round, of at least about four inches, or comparable sizes if the material is in another shape.

5. The ballistic material of claim 1, wherein the material is at least about twelve inches in thickness.

6. The ballistic material of claim 5, wherein center fire rounds up to .50 caliber do not penetrate more than about four or five inches into the material.

7. The ballistic material of claim 1, wherein the polymers have a density of 0.92 g/cm³, ±15%, a surface hardness of SD48, ±15%, a tensile strength of 20 MPa, ±15%, a flexural modulus of 0.35 GPa, ±15%, a linear expansion of 20×10−5/° C., ±15%, elongation at break of 500%, ±15%, strain at yield of 20%, ±15%, and a melting temperature range of around 120 to around 160° C.

8. The ballistic material of claim 1, wherein the ballistic material is formed by injection molding of thermoplastic polymers.

9. The ballistic material of claim 1, wherein the ballistic material is formed by reaction injection molding (RIM) of thermoset polymers.

10. The ballistic material of claim 1, wherein the polymers comprise between about 59% and about 90% linear low density polyethylene (“LLDPE”) by weight of the polymers, between about 5% and about 40% Hybar™ (5125) by weight of the polymers, and between about 0 and about 35 Engage (8100), by weight of the polymers.

11. The ballistic material of claim 10, wherein the polymers comprise preferably between about 5 and about 35% by weight of the polymers of Engage (8100).

12. The ballistic material of claim 9, wherein the monomers used in the reaction injection molding process comprise Dow system spectrum RW 509 (Polyol)+Isonate MDI 5181.

13. The ballistic material of any of claims 1-12, further comprising objects made of a hardened material interspersed throughout the interior volume of the material.

14. The ballistic material of claim 13, wherein the hardened material is selected from the group consisting of steel, ceramic, and bullets.

15. The ballistic material of claim 13, wherein the hardened material is bullets.

16. The ballistic material of claim 13, wherein the hardened material is ball bearings.

17. The ballistic material of claim 13, wherein the hardened material is oriented within the material in a planar orientation.

18. The ballistic material of claim 13, wherein the hardened material is oriented within the material in a plurality of planar orientations.

19. The ballistic material of claim 13, wherein the hardened material is positioned at a certain depth within the material to enable the polymer to reduce the velocity of the projectile, and with a certain depth of the material behind the object to catch any fragments formed when the projectile strikes one or more objects.

20. The ballistic material of any of claims 1-19, comprising interlocking portions such that a plurality of blocks of the material can be connected to each other.

21. The ballistic material of claim 20, wherein the interlocking portions are male and female connectors.

22. A backstop for a firing range, comprising a plurality of the blocks of claim 20.

23. Aircraft, spacecraft, ships, or ground vehicles, comprising a plurality of the block of claim 20.

24. Training targets, comprising a plurality of the blocks of claim 120.

25. Protection for temporary or mobile military and/or police installations, buildings, or bunkers, comprising a plurality of the blocks of claim 20.

26. Pipelines comprising a plurality of the blocks of claim 20.

27. A polymeric composition as disclosed herein.

28. A method of making a polymeric composition as disclosed herein.

29. A projectile absorbing armor as disclosed herein.

30. A block for building a projectile absorbing armor as disclosed herein.

31. A method for making a projectile absorbing material as disclosed herein.

32. Any other inventive features either individually or in combination that are disclosed herein.
